(19) United States
(12) Patent Application Publication
(10) Pub. No.: US 2014/0097606 A1
(43) Pub. Date: Apr. 10, 2014

(54) BINDING COVER FOR BINDING A BUNDLE OF LEAVES

(71) Applicant: Guido Peleman, Antwerpen (BE)

(72) Inventor: Guido Peleman, Antwerpen (BE)

(21) Appl. No.: 14/124,328

(22) PCT Filed: May 29, 2012
(86) PCT No.: PCT/IB2012/001036

§ 371 Date: Dec. 6, 2013

(30) Foreign Application Priority Data
Jun. 9, 2011 (BE) 2011/0351

(51) Int. Cl. B42D 3/00; B42C 9/00

(52) U.S. Cl. CPC B42D 3/002; B42C 9/00
USPC 281/21.1; 281/29; 412/8

(57) ABSTRACT

A binding cover for binding a pre-bound bundle (11) of leaves, whereby the binding cover (1) is formed by a U-shaped back (2) with a base (5) and two upright arms (6-7) and flaps (3-4) attached thereto, characterised in that at least a part of the inside (12) of the back (2) is provided with a self-adhesive glue (10) in order to hold the bundle (11) in the back (2).

The present invention relates to a binding cover for binding a bundle of leaves.

Various systems are already known that enable a bundle of leaves to be bound into a binding cover.

In these systems use is made of a binding cover formed by a back and two flaps attached thereto.

In a first type of system, the back is made of steel and hot-melt adhesive is applied to the back.

In order to apply this system, a binding device is required that enables the back with the hot-melt adhesive to be heated in order to make the hot-melt adhesive liquid during binding, so that an edge of the bundle to be bound can be pressed into the liquid adhesive, and after the back has cooled down the hot-melt adhesive is hard again such that the bundle is firmly bonded in the back.

A second type of system is based on a bundle of leaves that must first be provided with a series of perforations along an edge of the bundle, whereby in order to bind it use is made of a binding back with flexible rings that are put through the perforations of the bundle by means of a device specially designed for this purpose.

An advantage of both systems is that loose leaves can be bound. However a disadvantage is that the user must invest in devices specially designed for this purpose, i.e. the heating device for the first system, or a perforator and a binding device for the second system.

The binding can only be done at the place where the appropriate devices are located.

A third type of system is intended to bind a pre-bound bundle into a binding cover. For example, the bundle to be bound is first stapled together along an edge with a traditional stapler.

The invention relates to this last type of system for binding a pre-bound bundle.

Such a system is described in BE 1.017.065, which uses a binding folder with a U-shaped back and flaps attached thereto, and whereby there is an adhesive strip on the inside of the flaps to glue the bundle into the folder along the outermost endpapers.

However, a disadvantage of this system is that the adhesive strip always remains clearly visible, which is a problem for demanding users.

Moreover, the adhesive strip must be relatively wide to obtain sufficient adhesive strength to prevent the adhesive strip detaching from the bound bundle when the folder is opened.

In addition, an adhesive bond is obtained with this system that only acts on an outermost endpaper of the bundle, and this endpaper must be sufficiently strong to ensure that the endpaper does not tear when the folder is used.

The purpose of the present invention is to provide a solution to one or more of the aforementioned and/or other disadvantages.

To this end the invention concerns a binding cover for binding a pre-bound bundle of leaves, whereby the binding cover is formed by a U-shaped back with a base and two upright arms and flaps attached thereto, whereby at least a part of the inside of the back is provided with a self-adhesive glue in order to hold the bundle in the back.

Herein, a self-adhesive glue is an adhesive which it tacky on its own, and which does not need to undergo drying or a physical or chemical transformation to develop its adhesive strength. Normally these are elastomers mixed with resins and/or plasticisers.

With such a binding cover, the binding of a pre-bound bundle of leaves is very simple. It is sufficient to push the bundle to be bound into the back up against the self-adhesive glue.

Beyond all expectations a very strong bond is obtained with such a binding element according to the invention, notwithstanding the prejudices in this respect that only limited adhesive strength can be obtained with self-adhesive glue.

This last aspect might indeed be true with regard to the detaching forces perpendicular to the plane of a layer of self-adhesive glue, but the merit of the inventor is to have established that relatively large shear forces can be accommodated with such a layer of self-adhesive glue and to have applied this to bind a bundle using this type of glue without the need for additional other means or glues to secure the bound bundle in the cover.

A suitable specific device is not really needed for binding. Only a traditional stapler is needed that is generally available in any case, and which moreover is not expensive and takes up little space and which anyone can use, even without intensive training.

Because the binding glue is on the inside of the back, after binding a bundle the glue is as good as invisible on the outside of the cover.

Another advantage is that the binding cover is simple to manufacture.

A further advantage is that the bundle is not damaged by bonding it in the binding cover, and remains of the adhesive are not left behind on the bundle when the bundle is taken out of the binding cover.

An additional advantage is that when the binding cover with an already bound bundle of leaves is opened, the glue does not pull on the outermost endpapers of the bundle, such that they cannot be damaged as a result.

Preferably the glue is a pressure sensitive glue. This means that the glue forms a bond when pressure is applied between to articles which are to be bonded, whereby the bond remains when the pressure is lifted.

Preferably at least a part of the inside of one of the two arms of the back are provided with self-adhesive glue to build up sufficient shear strength against the removal of the bound bundle from the back.

According to a preferred characteristic, the back is at least partly made of a flexible elastic material, so that the arms can be moved towards and away from one another in a reversible way.

In this way it is easy to take a bound bundle out of the binding cover without damage by moving the arms of the back away from one another, for which only a little force is required in view of the limited adhesive strength of the self-adhesive glue in a direction perpendicular to the layer of self-adhesive glue.

This also has the advantage that a continuous, albeit relatively weak, force is applied at right angles to the bonding surface between the bundle and the arms, and that the arms and the bundle constantly remain in contact during normal use.

Although this pressure is insufficient to clamp the bundle into the back, nor is intended to do this, it ensures that the glue may only be subjected to shear forces, no tensile forces, which forces the glue is capable to withstand.

Thus the binding cover can be reused a number of times and it is also possible to reposition a bound bundle in the binding cover if not good to begin with.

In order to be able to easily move the arms of the back away from one another, it is preferable for the flaps to be rigid flaps that are connected to the back in a hinged way via a fold line.

In order to fold open the arms, the rigid flaps are folded back along the aforementioned fold line to against the corresponding arms of the back and then folded back somewhat further to open the arms. The flaps thus act as a kind of lever in order to pull open the arms of the back without too much difficulty in order to remove a bundle from the back or to put one in.

With the intention of better showing the characteristics of the invention, a few preferred embodiments of a binding cover according to the invention are described hereinafter by way of an example, without any limiting nature, with reference to the accompanying drawings, wherein:

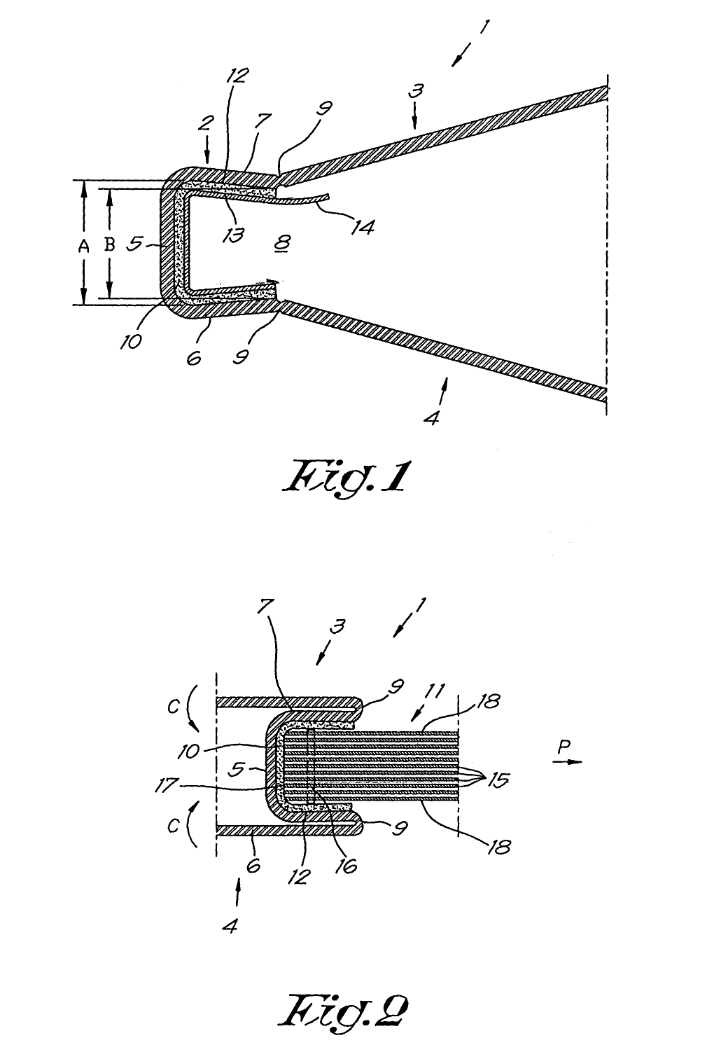

FIG. 1 schematically shows a cross-section of a binding cover according to the invention;

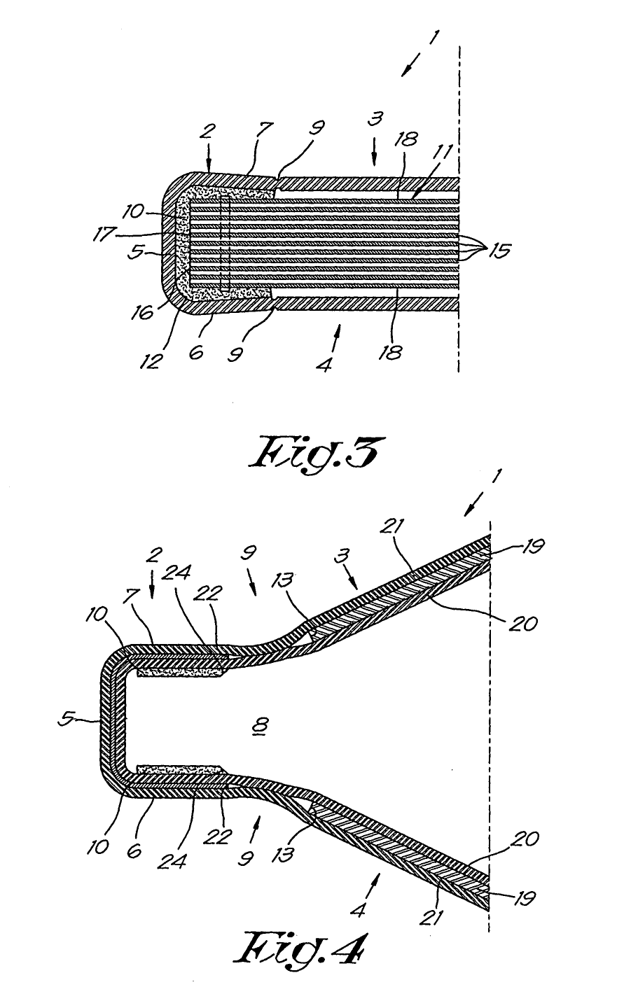

FIGS. 2 and 3 show the binding cover of FIG. 1 during different stages when securing the bundle;

FIGS. 4, 5 and 6 show three variants of a binding cover according to the invention.

FIG. 1 schematically shows a binding cover 1 for securing a bundle of pre-bound leaves, that primarily consists of a back 2 and two flaps 3-4.

In a practical embodiment of the invention the back 2 is made of a somewhat flexible elastic material, such as metal or a rigid plastic for example.

In the embodiment shown, the binding cover 1 is primarily built up from a U-shaped back 2 with a base 5 and two arms 6-7.

It is thereby possible that both arms 6-7 are parallel to one another, or which, at rest as shown in FIG. 1, taper towards one another from the base 5.

In this embodiment the distance A between the arms 6-7 at the base 5 is larger than the distance B between the arms 6-7 at the ends, all such that these ends define a narrower slot or entry opening 8 for the bundle to be inserted.

In the embodiment of FIG. 1, the back 2 and flaps 3-4 are formed as a continuous whole and are provided with two fold lines 9 that form the separation between the back 2 and the flaps 3-4.

In the simplest embodiment, this line 9 is formed by a local impressed zone in the binding cover 1.

In alternative embodiments it is not excluded that only one of the two flaps 3-4 is connected to the back 2 in a hingeable way.

According to the invention the binding cover 1 is provided with a self-adhesive glue 10 that enables, after inserting a pre-bound bundle of leaves 11 into the back 2, the aforementioned bundle 11 to be secured to the inside 12 of the back 2.

In a practical embodiment the self-adhesive glue 10 is a pressure-sensitive glue. The glue 10 preferably contains microspheres or elastomer copolymers.

In the most preferred embodiment, as shown in FIG. 1, the glue 10 covers the entire or practically entire inside 12 of the back 2, but this is not strictly necessary.

In a practical embodiment of the invention, the glue 10 is provided with a removable protective sheet 13 that can be removed before securing a bundle 11 in the binding cover 1.

The dimensions of this protective sheet 13 are preferably somewhat larger than the dimensions of the glue layer 10, all such that the sheet 13 can be easily pulled away along a free edge 14.

In other embodiments it is also possible for the dimensions of the protective sheet 13 and adhesive strip 10 to be the same.

In a practical embodiment of the invention the glue 10 extends over the entire length of the binding cover 1.

Preferably enough glue 10 is used to obtain a sufficiently large adhesive area that can prevent the unwanted detachment of the bundle 11 from the binding cover 1.

The aforementioned glue 10 enables the user to securely fasten the bundle 11 in the binding cover 1 without having to use other means or other types of glue for this purpose. An example of a suitable self-adhesive glue is for example the glue PLASTOFLEX 9058 of ADLEY Adhesives®.

The method for binding a bundle of leaves 15 by means of a binding cover 1 according to the invention is very simple and as follows.

In a first step the leaves 15 to be bound are bound by applying one or more staples 16 for example, to form a bound bundle 11.

It is clear that the aforementioned staples 16 are preferably located close to the edge 17 of the bundle 11 to be bound.

In a subsequent step the binding cover 1 can be folded open and if desired the flaps 3-4 can be folded open along the fold lines 9 provided, up to against the arms 6-7 of the back. When folding the flaps 3-4 further open, as shown by the arrows C in FIG. 2, the opening 8 of the back 2 is further pulled open because the arms 6-7 are pulled away from one another.

In so doing the entry opening 8 for the bundle 11 is made somewhat larger and the bundle 11 can easily be inserted into the back 2, and if desired pushed along the longitudinal direction of the back 2 until the bundle 11 is in the desired position in the binding cover 1.

The edge 16 of the bundle thus comes into contact with the glue 10 on the base 5.

When the flaps 3-4 are released, the arms 6-7 of the back 2 will spring closed again due to the elasticity, whereby the glue 10 on the inside of the arms 6-7 comes into contact with the outermost endpapers 18 of the bundle 11.

The bundle 11 is now firmly bound primarily thanks to the high shear strength of the glue 10 on the outermost endpapers 18 of the bundle 11, which opposes the bundle 11 from being pulled out in a transverse direction P, as shown in FIG. 2.

The binding cover can now be folded closed for filing, as shown in FIG. 3.

If desired, the bound bundle 11 can again be removed from the binding cover 1 by again folding the back 2 open by folding open the flaps 3-4 as described above further to FIG. 2.

As a result, the glue 10 on the inside 12 of the arms 6-7 comes away from the outermost endpapers 18 of the bundle 11, such that the aforementioned shear strength is eliminated and the bundle 11 can thus be easily removed without much force.

As a result, only the adhesive force of the glue 10 on the base 5 exerted on the edge 16 has to be overcome, which is not large as this adhesive force acts in a direction perpendicular to the plane of the self-adhesive layer of glue 10.

Although the aforementioned glue 10 ensures a sufficiently firm fastening in the binding cover 1, the resistance to transverse tensile forces P can be additionally increased due to the staples 16 protruding behind the edges of the arms 6-7.

It is clear that the invention is based on the unexpected finding that an adhesive strip of a soft type of glue in fact has an isotropic effect in the sense that a shear force in the direction of the arrow P will experience high resistance, while a peeling force or tearing force will experience little resistance.

FIG. 4 shows an alternative embodiment of the invention, whereby the binding cover 1 is built up of a U-shaped back 2 and two separate flaps 3-4 that primarily consist of a rigid support 19 provided with two covering layers 20-21, respectively an inside covering 20 and outside covering 21.

In this embodiment the flaps 3-4 and the back 2 are connected together by means of a flexible inside and outside covering 20-21.

In this embodiment, the edges 22 of the back 2 are a small distance from the edges 23 of the supports 19, such that the hingeable fold line 9 is formed by the inside covering 18 and outside covering 19.

In this case the glue 10 is only provided on the inside of both arms 6-7.

The edges of the glue layer 10 directed to the outside are provided with a bevelled edge 24 that provides a conical guide for the bundle 11 into the back 2, and which thus avoids the bundle 11 knocking against the edges of the glue layer 10 when inserted into the back 2.

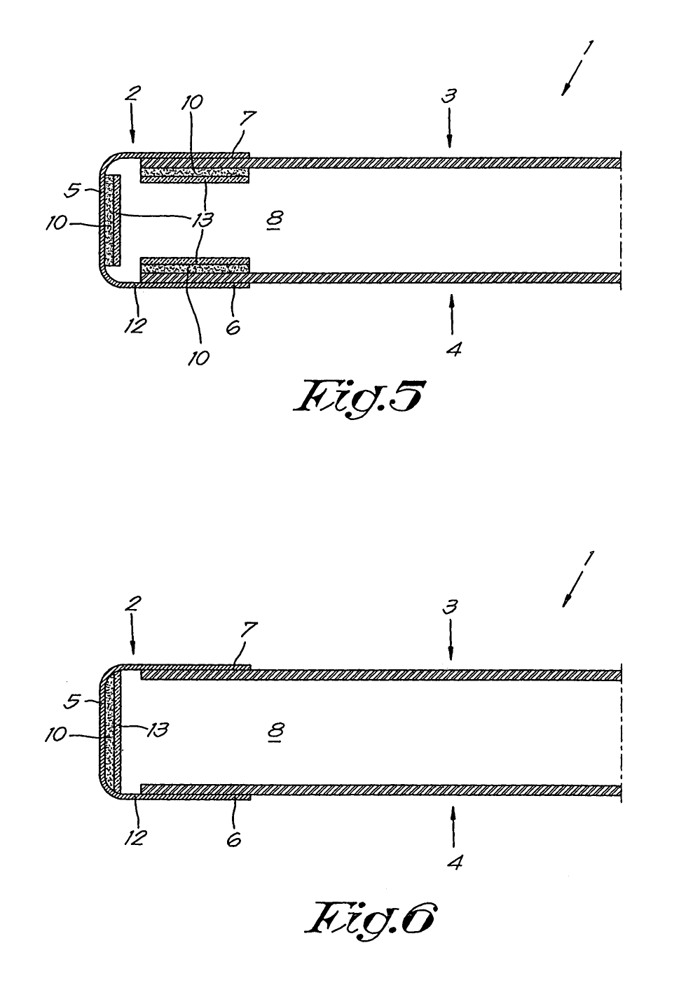

FIG. 5 shows another variant of a binding cover 1 according to the invention, consisting of a metal back 2 and flaps 3-4 of cardboard or plastic, or another material that are secured with an edge to the inside 12 of the back 2, and with this edge as it were forms part of the back 2. In this case the glue 10 is applied indirectly with the intervention of a flap 3-4 to the inside of the back 2.

Self-adhesive glue 10 is also applied to the base, however this time as a separate strip without running into the glue on the arms 6-7. Each adhesive strip 10 is provided separately with a protective layer 13.

FIG. 6 shows another variant of a binding cover, whereby in this case only self-adhesive glue 10 is provided on the base 5 of the back 2, whereby this glue 10 is covered with a protective sheet 13.

The present invention is by no means limited to the embodiments described as an example and shown in the drawings, but a binding cover according to the invention for binding a bundle of leaves can be realised in all kinds of variants, without departing from the scope of the invention.

1. Binding cover for binding a pre-bound bundle (11) of leaves, whereby the binding cover (1) is formed by a U-shaped back (2) with a base (5) and two upright arms (6-7) and flaps (3-4) attached thereto, characterised in that at least a part of the inside (12) of the back (2) is provided with a self-adhesive glue (10) in order to hold the bundle (11) in the back (2).

2. Binding cover according to claim 1, characterised in that aside from the aforementioned self-adhesive glue (10) in the back, it contains no other glue or other means to hold the bundle (11) in the binding cover (1).

3. Binding cover according to claim 1, characterised in that at least a part of the inside (12) of one or both arms (6-7) of the back (2) are provided with self-adhesive glue (10).

4. Binding cover according to claim 1, characterised in that the base (5) of the back (2) is at least partially provided with a self-adhesive glue (10).

5. Binding cover according to claim 1, characterised in that the back (5) is provided with self-adhesive glue (10) over its entire or practically entire inside (12).

6. Binding cover according to claim 1, characterised in that the self-adhesive glue (10) is covered with at least one removable protective sheet (13) that must first be removed before binding the bundle (11).

7. Binding cover according to claim 1, characterised in that the adhesive area of the glue (10) is large enough to prevent the unwanted manual detachment of the bundle (11) from the back (2) by a transverse shear force (P) being exerted on the bundle (11).

8. Binding cover according to claim 1, characterised in that the self-adhesive glue (10) is a pressure-sensitive glue.

9. Binding cover according to claim 1, characterised in that the self-adhesive glue (10) contains microspheres.

10. Binding cover according claim 1, characterised in that the self-adhesive glue (10) contains elastomer copolymers.

11. Binding cover according to claim 1, characterised in that the back (2) is at least partly made of a flexible elastic material, so that the arms can be moved away from one another and towards one another in a reversible way.

12. Binding cover according to claim 1, characterised in that the arms (6-7) of the back (2) taper obliquely from the base (5) towards one another to form a narrow opening (8) between which the bundle (11) can be inserted.

13. Binding cover according to claim 1, characterised in that the flaps (3-4) are rigid flaps that are connected to the back (2) in a hingeable way via a fold line (9).

14. Binding cover according to claim 13, characterised in that the flaps (3-4) can be laid flat against the arms (6-7) by hinging them and are sufficiently rigid to be able open the arms (6-7) when pushed towards each other in this position.

15. Binding cover according to claim 1, characterised in that the glue (10) is covered by a protective sheet (13) having a free edge (14) to simply its removal.

16. A method for binding a pre-bound bundle (11) of sheets into a binding cover (1) which is formed by a U-shaped back (2) with a base (5) and two upright arms (6-7) and flaps (3-4) attached thereto), comprising applying a self-adhesive glue (10) to said binding cover (1).

17. The method according to claim 17, characterised in that this take place in a binding cover (1) which is shaped such that, for retaining the bundle (11) in the binding cover, the glue does not need to be able to withstand any or any significant tensile forces, but only needs to be able to withstand shear forces.

18. The method according to claim 16, characterised in that it concerns a pressure sensitive glue.

19. The method according to claim 16, characterised in that this take place on at least a part of the inside (12) of one or both arms (6-7).

20. The method according to claim 16, characterised in that this take place in a binding cover (1) of which the back (2) is at least partly made of a flexible elastic material, so that the arms (6-7) can be moved away from one another and towards one another in a reversible way.
